(19) United States
(12) Patent Application Publication
(10) Pub. No.: US 2024/0232306 A1
(43) Pub. Date: Jul. 11, 2024

(54) LIVENESS DETECTION FOR AN ELECTRONIC DEVICE

(71) Applicant: QUALCOMM Incorporated, San Diego, CA (US)

(72) Inventors: Kapil KAMRA, Sunnyvale, CA (US); Ashok BHATIA, San Diego, CA (US); Deepankar KATYAL, Seattle, WA (US); Karthik BALASUBRAMANIAN, San Diego, CA (US)

(21) Appl. No.: 18/153,184

(22) Filed: Jan. 11, 2023

(51) Int. Cl. G06F 21/31

(52) U.S. Cl. CPC G06F 21/316; G06F 2221/2133

(57) ABSTRACT

In some aspects, an electronic device may receive multiple inputs that each indicate current sensor information related to a liveness state associated with a human user. The electronic device may generate, based at least in part on the multiple inputs, liveness information that includes a liveness assessment word that represents the liveness state associated with each of the multiple inputs and a liveness indicator that indicates whether a human user is actively handling the electronic device. Numerous other aspects are described.

### FIELD OF THE DISCLOSURE

Aspects of the present disclosure generally relate to liveness detection and, for example, to using various sensor inputs on an electronic device to detect whether the electronic device is being handled or operated by a human user.

### BACKGROUND

Liveness detection refers to techniques to determine whether an interaction with an electronic device was performed by a live and physically present human being or performed by an automated bot, an inanimate spoof artifact, injected video and/or data, or another artificial construct designed to simulate human behaviors. Liveness detection may be used as an important security measure in various use cases, including fraud prevention and identity verification.

### SUMMARY

Some aspects described herein relate to a method performed by an electronic device. The method may include receiving multiple inputs that each indicate current sensor information related to a liveness state associated with a human user. The method may include generating, based at least in part on the multiple inputs, liveness information that includes a liveness assessment word that represents the liveness state associated with each of the multiple inputs and a liveness indicator that indicates whether a human user is actively handling the electronic device.

Some aspects described herein relate to an electronic device for wireless communication. The electronic device may include a memory and one or more processors coupled to the memory. The one or more processors may be configured to receive multiple inputs that each indicate current sensor information related to a liveness state associated with a human user. The one or more processors may be configured to generate, based at least in part on the multiple inputs, liveness information that includes a liveness assessment word that represents the liveness state associated with each of the multiple inputs and a liveness indicator that indicates whether a human user is actively handling the electronic device.

Some aspects described herein relate to a non-transitory computer-readable medium that stores a set of instructions for wireless communication by a one or more instructions that, when executed by one or more processors of an electronic device. The set of instructions, when executed by one or more processors of the electronic device, may cause the electronic device to receive multiple inputs that each indicate current sensor information related to a liveness state associated with a human user. The set of instructions, when executed by one or more processors of the electronic device, may cause the electronic device to generate, based at least in part on the multiple inputs, liveness information that includes a liveness assessment word that represents the liveness state associated with each of the multiple inputs and a liveness indicator that indicates whether a human user is actively handling the electronic device.

Some aspects described herein relate to an apparatus for wireless communication. The apparatus may include means for receiving multiple inputs that each indicate current sensor information related to a liveness state associated with a human user. The apparatus may include means for generating, based at least in part on the multiple inputs, liveness information that includes a liveness assessment word that represents the liveness state associated with each of the multiple inputs and a liveness indicator that indicates whether a human user is actively handling the electronic device.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which liveness detection techniques may be used to determine whether an electronic device is being handled by a human user, in accordance with the present disclosure.

FIG. 2 is a diagram illustrating example components of a device, in accordance with the present disclosure.

FIG. 3 is a diagram illustrating an example associated with liveness detection techniques that may be used to determine whether an electronic device is being handled by a human user, in accordance with the present disclosure.

FIG. 4 is a diagram illustrating an example of training and using a machine learning model in connection with liveness detection techniques that may be used to determine whether an electronic device is being handled by a human user, in accordance with the present disclosure.

FIG. 5 is a flowchart of an example process associated with liveness detection techniques that may be used to determine whether an electronic device is being handled by a human user, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

There are various scenarios where machine-based entities are used to simulate human actions when manipulating electronic devices in an effort to convince computers or human users that the electronic devices are being operated or handled by physically present human beings. According to some estimates, mobile network operators, marketers, and/or other entities are unnecessarily spending billions of dollars to mitigate fraud that is enabled by electronic devices simulating human actions. For example, a subscriber identity module (SIM) (sometimes referred to as a SIM card) is a chip that gives an electronic device an identity on a mobile (e.g., cellular) network and allows the electronic device to be controlled through the mobile network (e.g., to trigger calls, text, and/or data). In some cases, hundreds or thousands of electronic devices may be deployed in a SIM farm to send short message service (SMS) text messages and/or simulate application browsing behavior, which can increase traffic congestion in a mobile network and significantly increase costs that mobile network operators incur to terminate the traffic associated with the SIM farm.

The problem with electronic devices simulating human behavior is reaching unprecedented levels due to technology that allows SIM farm operators to send bulk texts or pre-recorded voice messages to target audiences at ultra-fast speeds, the demand for inexpensive methods to contact prospective customers or targets, and the dramatic rise in digital advertising and message-based marketing campaigns across mobile devices. For example, the electronic devices in a SIM farm typically use consumer-grade SIM cards that often offer unlimited texts, minutes, and/or cellular data usage. Accordingly, SIM farms offer exceptionally inexpensive per-message rates with few considerations regarding their legality or ethics, which makes SIM farms attractive to scammers and fraudsters and increases complaints by victim subscribers that are normally directed to mobile network operators to investigate and remediate.

Although SIM farms can have throughput rates that vary substantially, a SIM farm can generally be used to send up to tens of thousands of messages per hour in a typical campaign, which can put significant strain on a mobile network. Furthermore, in some cases, the target numbers are used indiscriminately and are spammed, which is illegal in many countries that prohibit organizations from contacting potential customers electronically unless there is a prior relationship with the potential customers. Furthermore, for mobile network operators, the practices used in SIM farms may violate terms of service, as the prepaid consumer SIM cards typically used in SIM farms tend to prohibit illegal, unauthorized, or nuisance calls. Although the terms of service provide mobile network operators with broad latitude to deny access to SIM cards that are sending out hundreds of SMS messages per hour or otherwise simulating human behavior in a manner that violates the terms of service, the main problem that mobile network operators face is differentiating whether a device is being actively used, handled, or otherwise operated by a human user or passively sitting in a SIM farm.

In some aspects, as described herein, an electronic device may include various sensors that generate signals that may indicate a liveness state associated with an entity operating or otherwise handling the electronic device, and inputs from the various sensors may be used alone or in combination with one another to generate liveness information that may include a liveness indicator that indicates whether the electronic device is being actively handled by a human user or whether the electronic device is being manipulated to simulate human behaviors. For example, in some aspects, the electronic device may include a machine learning engine that can be trained to differentiate inputs from an actual human user from device interactions that are performed by an automated bot, an inanimate spoof artifact, injected video and/or data, or other artificial constructs, and the machine learning engine can then be used to generate the liveness information that indicates whether a current input or a current set of inputs is attributable to a live human user or a machine (e.g., a bot or a spoof) based on the various sensor inputs. Additionally, or alternatively, the electronic device may use a thresholding technique to determine whether the various sensors inputs indicate that the electronic device is being handled by a live human user or a machine (e.g., based on whether a threshold number or threshold proportion of the sensor inputs indicate that the electronic device is being handled by a live human user). In this way, the liveness information may be consumed on the electronic device and/or sent to a network node (e.g., in connection with a data collection campaign or a request to send traffic over a mobile network) to support any suitable use case that may depend on the liveness (or non-liveness) of an entity operating the electronic device (e.g., determining whether to terminate an SMS message or other traffic associated with the electronic device and/or verifying an identity of a user of the electronic device).

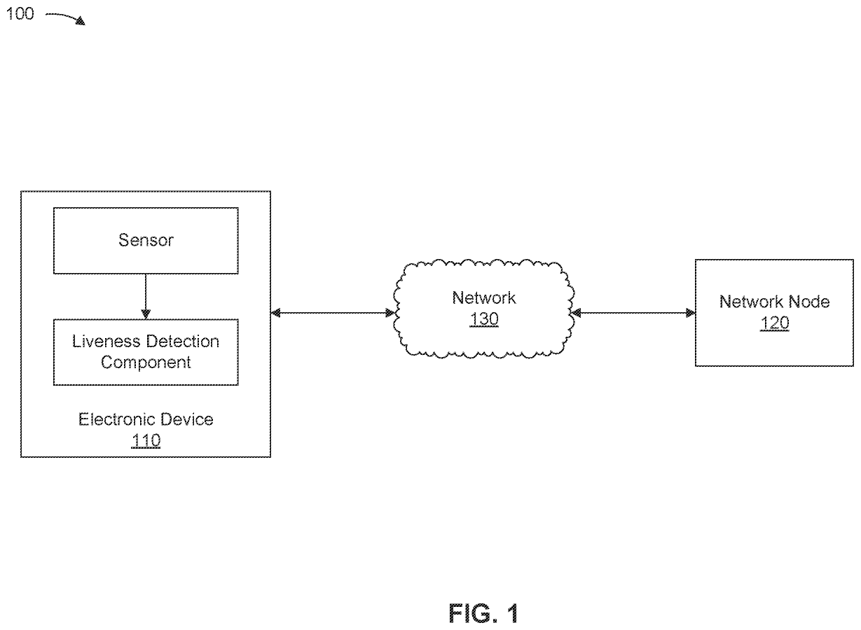

FIG. 1 is a diagram illustrating an example environment 100 in which liveness detection techniques may be used to determine whether an electronic device is being handled by a human user, in accordance with the present disclosure. As shown in FIG. 1, the environment 100 may include an electronic device 110, a network node 120, and a network 130. Devices of the environment 100 may interconnect via wired connections, wireless connections, or a combination of wired and wireless connections.

The electronic device 110 includes one or more devices capable of performing liveness detection based on various sensor inputs that indicate current sensor information related to a liveness state associated with a human user. For example, as shown, the electronic device 110 may include one or more sensors that can each generate an input related to a liveness state associated with a human user, and the electronic device 110 may include a liveness detection component that can generate, based at least in part on the inputs provided by the one or more sensors, liveness information that includes a liveness assessment word that represents the liveness state associated with each of the multiple inputs and a liveness indicator that indicates whether a human user is actively handling the electronic device 110. More specifically, the electronic device 110 may include a wired and/or wireless communication and/or computing device, such as a user equipment (UE), a mobile phone (e. g., a smart phone, a radiotelephone, and/or the like), a laptop computer, a tablet computer, a handheld computer, a desktop computer, a gaming device, a wearable communication device (e.g., a smart wristwatch, a pair of smart eyeglasses, and/or the like), or the like.

Similar to the electronic device 110, the network node 120 includes one or more devices capable of receiving, generating, storing, processing, and/or providing information related to a liveness state associated with a human user. For example, the network node 120 may include a base station (a Node B, a gNB, and/or a 5G node B (NB), among other examples), a UE, a relay device, a network controller, an access point, a transmit receive point (TRP), an apparatus, a device, a computing system, one or more components of any of these, and/or another processing entity configured to perform one or more aspects of the techniques described herein. For example, the network node 120 may be an aggregated base station and/or one or more components of a disaggregated base station.

The network 130 includes one or more wired and/or wireless networks. For example, the network 130 may include a cellular network (e.g., a Long-Term Evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

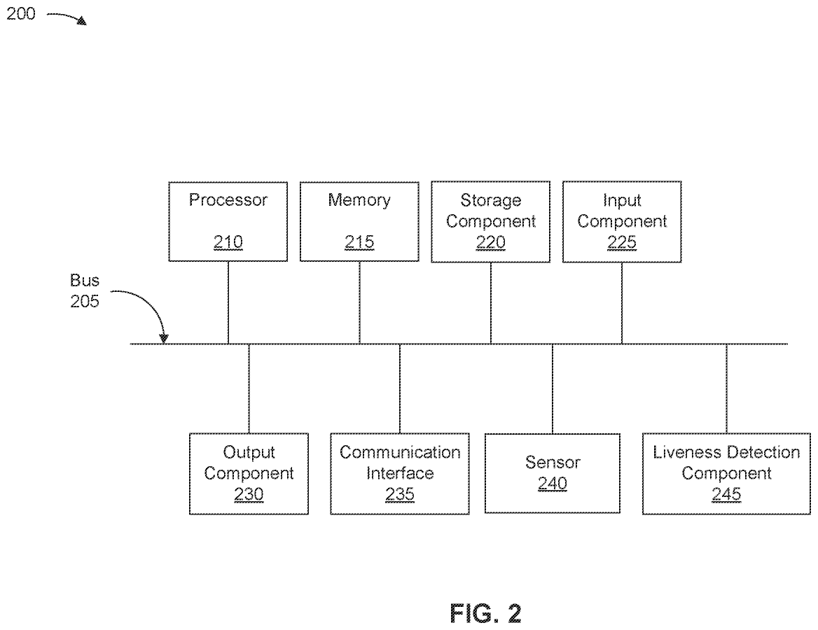

FIG. 2 is a diagram illustrating example components of a device 200, in accordance with the present disclosure. Device 200 may correspond to the electronic device 110 and/or the network node 120 shown in FIG. 1. In some aspects, the electronic device 110 and/or the network node 120 may include one or more devices 200 and/or one or more components of device 200. As shown in FIG. 2, device 200 may include a bus 205, a processor 210, a memory 215, a storage component 220, an input component 225, an output component 230, a communication interface 235, a sensor 240, and/or a liveness detection component 245.

Bus 205 includes a component that permits communication among the components of device 200. Processor 210 is implemented in hardware, firmware, or a combination of hardware and software. Processor 210 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 includes one or more processors capable of being programmed to perform a function. Memory 215 includes a random access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 includes a component that provides output information from device 200 (e.g., a display, a speaker, a haptic feedback component, and/or an audio or visual indicator).

Communication interface 235 includes a transceiver-like component (e.g., a transceiver and/or a separate receiver and transmitter) that enables device 200 to communicate with other devices, such as via a wired connection, a wireless connection, or a combination of wired and wireless connections. Communication interface 235 may permit device 200 to receive information from another device and/or provide information to another device. For example, communication interface 235 may include an Ethernet interface, an optical interface, a coaxial interface, an infrared interface, a radio frequency interface, a universal serial bus (USB) interface, a wireless local area interface (e.g., a Wi-Fi interface), and/or a cellular network interface.

The sensor 240 includes one or more wired or wireless devices capable of receiving, generating, storing, transmitting, processing, detecting, and/or providing information associated with a state of the device 200 and/or an environment surrounding the device 200, as described elsewhere herein. For example, the sensor 240 may include a motion sensor, an accelerometer, a gyroscope, a proximity sensor, a light sensor, a noise sensor, a pressure sensor, an ultrasonic sensor, a positioning sensor, a capacitive sensor, a timing device, an infrared sensor, an active sensor (e.g., a sensor that requires an external power signal), a passive sensor (e.g., a sensor that does not require an external power signal), a biological or biometric sensor, a smoke sensor, a gas sensor, a chemical sensor, an alcohol sensor, a temperature sensor, a moisture sensor, a humidity sensor, a radioactive sensor, a magnetic sensor, an electromagnetic sensor, an analog sensor, and/or a digital sensor, among other examples. The sensor 240 may sense or detect a condition or information related to a state of the device 200 and/or an environment surrounding the device 200 and transmit, using a wired or wireless communication interface, an indication of the detected condition or information to other components of the device 200 and/or other devices.

The liveness detection component 245 includes one or more devices capable of receiving, generating, storing, transmitting, processing, detecting, and/or providing liveness information based on one or more sensor inputs, as described elsewhere herein. For example, in some aspects, the liveness detection component 245 may generally receive various sensor inputs that indicate information potentially relevant to the liveness (e.g., presence) of a human user, and the liveness detection component 245 generate a liveness assessment word to indicate the liveness state of each input and a liveness indicator to indicate whether a human user is actively handling the device 200.

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication interface 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, device 200 includes means for performing one or more processes described herein and/or means for performing one or more operations of the processes described herein. For example, device 200 may include means for receiving multiple inputs that each indicate current sensor information related to a liveness state associated with a human user; means for generating, based at least in part on the multiple inputs, liveness information that includes a liveness assessment word that represents the liveness state associated with each of the multiple inputs and a liveness indicator that indicates whether a human user is actively handling the electronic device; or the like. In some aspects, such means may include one or more components of device 200 described in connection with FIG. 2, such as bus 205, processor 210, memory 215, storage component 220, input component 225, output component 230, communication interface 235, sensor 240, and/or liveness detection component 245.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

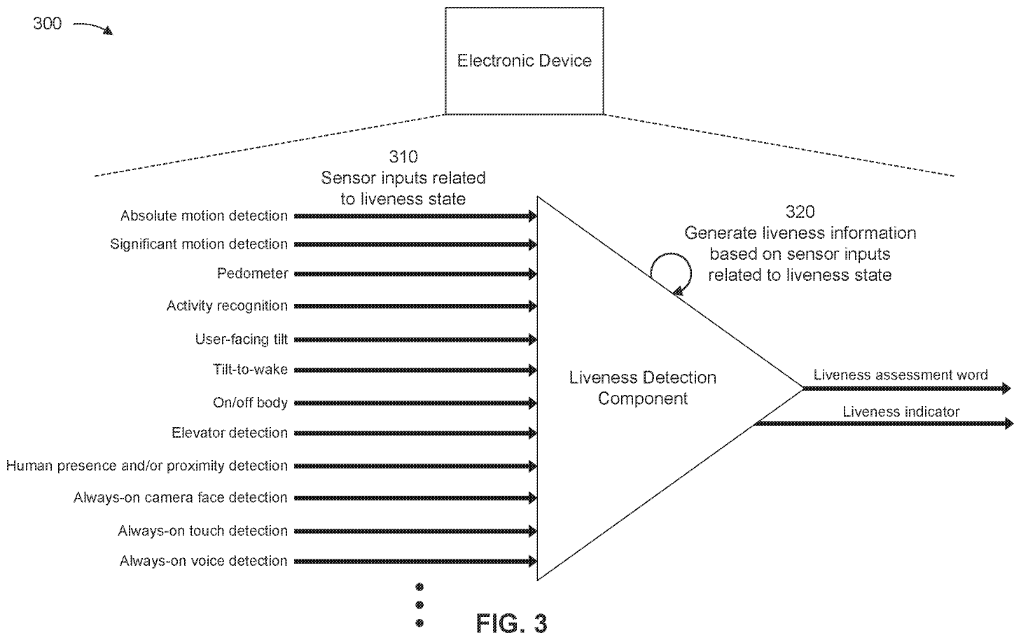

FIG. 3 is a diagram illustrating an example 300 associated with liveness detection techniques that may be used to determine whether an electronic device is being handled by a human user, in accordance with the present disclosure. As shown in FIG. 3, example 300 includes functions performed by an electronic device. In some aspects, the electronic device may communicate with a network node in a wireless network via a wireless access link (e.g., in connection with an SMS message, a data collection campaign, and/or other network-based application that depends on the physical presence of a live human user and/or detection of a machine attempting to simulate behaviors of a live human user). Additionally, or alternatively, the electronic device may perform the liveness detection techniques in a local context, where liveness information generated by the electronic device is consumed locally on the electronic device (e.g., in connection with a biometric authentication or other local application that depends on the physical presence of a live human user and/or detection of a machine attempting to simulate behaviors of a live human user).

As shown in FIG. 3, and by reference number 310, the electronic device may include a liveness detection component that may receive multiple inputs that each indicate current sensor information related to a liveness state associated with a human user. For example, in some aspects, the multiple inputs to the liveness detection component may each be associated with one or more sensors that are configured to use one or more algorithms to generate a signal that generally depends or indicates whether human motion, human activity, human presence, or the like is detected.

As shown in FIG. 3, the various sensor inputs may include an absolute motion detection input that may indicate whether the electronic device is absolutely still or in some form of motion. Furthermore, for cases where the electronic device is in motion, the various sensor inputs may include a significant motion detection input that may indicate whether the electronic device is in significant motion (e.g., traveling in a vehicle versus walking, which may depend on whether a velocity, acceleration, or other motion parameter satisfies a threshold), a pedometer input that may detect and count steps that are taken while the electronic device is in motion, and/or an activity recognition input that may indicate whether the motion of the electronic device indicates whether a user handling the electronic device is still, walking, running, traveling in a car, traveling on a bicycle, and/or traveling on a train, among other examples.

As further shown in FIG. 3, the various sensor inputs received by the liveness detection component may include one or more tilt recognition inputs, such as a user-facing tilt input that may indicate whether the electronic device is being held in an orientation that is directed toward a gaze of a user (e.g., indicating that the user is looking at the electronic device), which may have a first latency (e.g., 2 seconds), and/or a tilt-to-wake input that may indicate whether the electronic device has been moved into the orientation that is directed toward the gaze of a user in order to wake the electronic device from a locked state, a sleep state, or another inactive state (e.g., indicating that the user wants to wake the electronic device), which may have a second latency that is shorter than the first latency (e.g., 200 milliseconds).

As further shown in FIG. 3, the various sensor inputs received by the liveness detection component may include one or more inputs that may be used to detect whether an environment surrounding the user has a potential impact on performance of a wireless modem. For example, as shown, the various sensor inputs may include an on/off body detection input, which may indicate whether the electronic device is on the body of a user, and/or an elevator detection input that may indicate whether the device is in an elevator. For example, in some aspects, the electronic device may be subject to maximum permissible exposure (MPE) constraints that limit the transmit power that can be used by the electronic device in order to limit the radiated power of the electronic device when human tissue is present, and the on/off body detection input may be used to determine whether and/or an extent to which the MPE constraints are applicable to operation of the electronic device. Additionally, or alternatively, the electronic device may be configured to communicate using millimeter wave frequencies that tend to suffer from propagation loss, which may be worsened in cases where a user's body is blocking signals being transmitted or received by the electronic device. In a similar respect, wireless communication performance may be significantly worsened in elevators, whereby the elevator detection input can be used to indicate whether the electronic device is traveling within an elevator (e.g., while being held by a user).

As further shown in FIG. 3, the various sensor inputs received by the liveness detection component may include one or more biometric inputs. For example, as shown, the various sensor inputs may include a human presence and proximity detection input that may detect whether one or more humans are present within a first threshold distance (e.g., six feet) of the electronic device and/or within a second threshold distance (e.g., two feet) that indicates proximity to the electronic device. In some aspects, the human presence and proximity detection input may also indicate whether a single human is detected to be present or in proximity to the electronic device or whether there are multiple people detected to be present or in proximity to the electronic device. As further shown, the one or more biometric inputs may include an always-on camera face detection input, which may indicate whether a face is detected within a field of view of an always-on camera (e.g., for use in facial recognition applications) and/or whether one or more other faces are entering or exiting the field of view, an always-on touch input that may indicate whether a person is touching a screen of the electronic device, and/or an always-on audio input that may indicate whether a human voice is detected in proximity to the electronic device, among other examples.

In some aspects, the multiple inputs that are received by the liveness detection component may each include one or more bits to indicate a corresponding liveness state. For example, in some aspects, the absolute motion detector may include one bit that has a first value (e.g., zero) to indicate that the electronic device is still or a second value (e.g., one) to indicate that the electronic device is in motion. Similarly, the significant motion detector, the pedometer, activity recognition, the user-facing tilt, tilt-to-wake, on/off body, elevator detection, human presence and proximity detection, and/or always-on detection inputs may each include one bit that has a first value to indicate that the corresponding detection input is triggered by the associated sensor data or a second value to indicate that the corresponding detection input is not triggered by the associated sensor data. Additionally, or alternatively, one or more of the inputs may include multiple bits to indicate the corresponding liveness state. For example, in some aspects, the activity recognition input may include multiple (e.g., five) bits to distinguish different activities that may be detected, the human presence and proximity detection may include a first bit to indicate whether human presence is detected and a second bit to indicate whether human proximity is detected, or the like. However, it will be appreciated the number of bits associated with each input is illustrative, and that the number of bits associated with each input may vary (e.g., depending on the level of granularity provided by each respective input).

Furthermore, although various inputs are illustrated in FIG. 3 and described herein, it will be appreciated that more, fewer, and/or other suitable inputs may be provided to the liveness detection component to indicate the liveness state associated with the user or operator of the electronic device. For example, in some aspects, the inputs received by the liveness detection component may include location information (e.g., a current location in addition to historical locations visited by the electronic device), network statistics (e.g., network nodes visited, network applications used, or the like), dynamic scenarios (e.g., walking into and out of Wi-Fi range), device activities (e.g., playing music or games), health data (e.g., heart rate, respiratory rate, and/or sleep metrics), and/or other inputs that may be indicative of whether the electronic device is being operated by a real, physically present human being. Furthermore, in some aspects, the inputs received by the liveness detection component may include the sensor data or other source data that is used to generate the liveness detection inputs. For example, the pedometer input may include a daily step count, active duration, rest period, gait, and/or other step data in addition to the pedometer detection input that indicates whether the pedometer was triggered. In another example, the always-on camera face detection input may include an image or series of images that were analyzed to detect the presence of a face in addition to the always-on camera face detection input that indicates whether a face is within the field of view of the camera.

As further shown in FIG. 3, and by reference number 320, the electronic device may generate (e.g., using the liveness detection component) liveness information based on the various sensor inputs that each indicate a liveness state associated with a user of the electronic device (e.g., whether the user is a physically present live human being or a machine simulating human behaviors). For example, as shown in FIG. 3, the liveness information generated by the liveness detection component may include a liveness assessment word, which may be a multi-bit word that represents (e.g., encodes) the liveness state associated with each input received by the liveness detection component. In addition, as shown, the liveness information may include a liveness indicator that indicates whether the multiple inputs received by the liveness detection component are indicative (e.g., as a whole) of a human user actively handling the electronic device. For example, in some aspects, the liveness indicator may include a flag that has a first value to indicate that the multiple inputs received by the liveness detection component are indicative of a human user actively handling the electronic device or a second value to indicate that a non-human entity (e.g., an automated bot or SIM farm operator) is manipulating the electronic device to simulate human behaviors. Additionally, or alternatively, a value of the liveness indicator may indicate a probability that a human user is actively handling the electronic device based on the multiple inputs.

Accordingly, as described herein, the liveness detection component may generally receive various inputs that convey information potentially relevant to (e.g., indicative of) whether the electronic device is being handled by a live human being. Furthermore, because SIM farm operators or other entities are manipulating electronic devices to simulate human behaviors (e.g., in an effort to replicate or create the appearance of liveness), the liveness detection component may generate the liveness information based on a combination of multiple inputs to avoid or mitigate false positives that may otherwise occur using a single input. For example, in some cases, a SIM farm operator could place the electronic device in a dock or cradle that is then actuated to simulate steps that may trigger the pedometer detection input. However, if the pedometer detection input is triggered but the on/off body detection input indicates that the electronic device is off-body and/or the human presence and proximity detection inputs indicate that no human being is present or in proximity to the electronic device, the combination of inputs as a whole may be indicative of non-liveness (e.g., a human user would be expected to have the electronic device on or near their body when the pedometer detection is triggered).

Additionally, or alternatively, when the source data used to generate one or more of the liveness detection inputs is available to the liveness detection component, the source data associated with the one or more liveness detection inputs may be analyzed using a suitable liveness assessment algorithm to determine the corresponding liveness state. For example, in the case of the pedometer detection input, a step count that is perfectly regular in time (e.g., does not include any variation that would be expected from a human with a natural gait) and occurs over an extended time period (e.g., 12 or 24 hours) with little or no rest periods may indicate non-liveness, even if the pedometer detection input is triggered. In another example, in cases where the always-on camera face detection is triggered, the liveness assessment algorithm may evaluate a sequence of images or video data to detect blinks, facial expressions, head tilts, light reflections, and/or other indicators of liveness as opposed to an inanimate spoof artifact (e.g., a wax head or realistic three-dimensional mask) or injected video frames that were previously captured. In other examples, the liveness assessment algorithm for the always-on touch detection may search fingerprint data for indicators such as perspiration-based features (e.g., sweat or sweat pores), textural characteristics (e.g., surface coarseness), blood flow, or the like to differentiate natural skin from gelatin, silicone polymers, or fingerprint spoofs, and/or the liveness assessment algorithm for the always-on voice detection may analyze a voice audio sample to determine whether there are artifacts of recorded or synthetic voice. Accordingly, by analyzing the source data used to generate one or more of the liveness detection inputs across multiple modalities (e.g., motion, biometrics, usage, location, or the like), the liveness information may become more accurate and/or may increase the difficulty for a SIM farm operator, bot, or other non-human operator to replicate liveness.

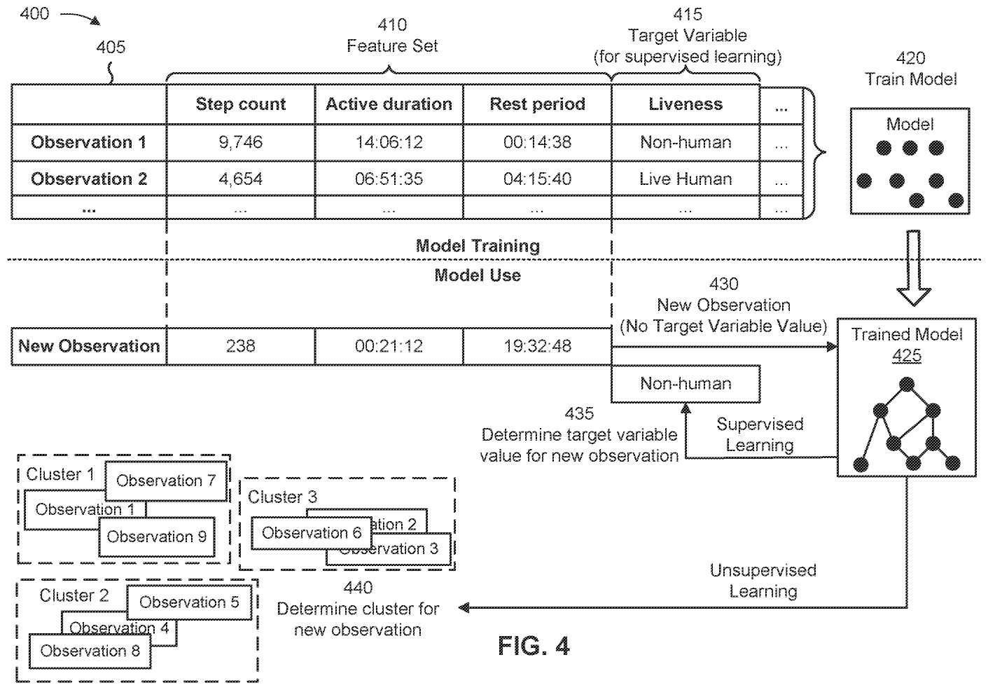

In some aspects, the liveness detection component may use one or more techniques to determine the value of the liveness indicator that indicates whether and/or a probability of whether the electronic device is being handled by a live human user. For example, in some aspects, the liveness detection component may use a thresholding technique, where the liveness indicator may indicate that the electronic device is being handled by a live human user based on a number of liveness detection inputs that indicate liveness satisfying (e.g., equaling or exceeding) a threshold or a proportion or ratio of liveness detection inputs that indicate liveness satisfying a threshold. Additionally, or alternatively, the thresholding technique may be time-constrained, where the liveness indicator may indicate that the electronic device is being handled by a live human user based on the number, proportion, or ratio of liveness detection inputs indicating liveness satisfying a threshold within a rolling time window (e.g., based on X inputs or X out of Y inputs indicating liveness within the most recent Z minutes). Additionally, or alternatively, in some aspects, the liveness detection component may use artificial intelligence or machine learning techniques (e.g., as described in more detail below with reference to FIG. 4) to generate the liveness information that indicates whether the electronic device is being operated by a human user or manipulated by a SIM farm operator, bot, or other non-human entity. For example, the artificial intelligence or machine learning techniques may evaluate the data associated with each input using an appropriate artificial intelligence or machine learning algorithm and/or may evaluate liveness assessments associated with different inputs in combination to arrive at a liveness assessment word and/or liveness indicator. For example, in some aspects, the artificial intelligence or machine learning techniques may be used to determine weights or other values associated with each respective input, which may increase the difficulty of replicating liveness as a whole even in cases where the non-human entity is able to replicate liveness and thereby bypass one or more liveness filters that are limited to evaluating one or a limited number of input modalities.

In some implementations, the liveness information that includes the liveness assessment word and the liveness indicator may be made accessible to one or more applications running on the electronic device via an application program interface (API). In this way, the liveness information may be consumed locally on the electronic device, and the application(s) that consume the liveness information may be configured to determine liveness based on any suitable combination of the liveness indicator and/or the various inputs that are represented in the liveness assessment word. For example, in some aspects, an application running on the electronic device may use the liveness indicator made accessible through the API as the liveness indicator for the application. Additionally, or alternatively, an application running on the electronic device may make an independent liveness decision regarding the user or operator of the electronic device based on one or more of the inputs in the liveness assessment word that are relevant to a particular context of the application. For example, if the application is associated with a biometric authentication, the application may determine the liveness state based on a subset of the inputs that include biometric indicators (e.g., the always-on camera face detection, always-on touch detection, and/or always-on audio human voice detection inputs). Additionally, or alternatively, the liveness information may be transmitted to a network node in connection with network activity performed by the electronic device. For example, the electronic device may transmit the liveness information to a network node in connection with a data campaign to assess usage patterns associated with live human users and simulated human activity, in connection with an SMS message, or the like. In such cases, the network node may use the liveness information to determine whether to allow the electronic device to perform one or more activities or access a network. For example, the network node may terminate an SMS message sent by the electronic device at a desired recipient device based on the liveness information indicating that the electronic device is being operated by a real human being, or the network node may take remedial action based on the liveness information indicating that the electronic device is being operated by a non-human entity (e.g., deny termination of the SMS message, block the electronic device from sending further SMS messages, and/or barring the electronic device from a network entirely).

As indicated above, FIG. 3 is provided as an example. Other examples may differ from what is described with respect to FIG. 3.

FIG. 4 is a diagram illustrating an example 400 of training and using a machine learning model in connection with liveness detection techniques that may be used to determine whether an electronic device is being handled by a human user, in accordance with the present disclosure. The machine learning model training and usage described herein may be performed using a machine learning system. The machine learning system may include or may be included in a computing device, a server, a cloud computing environment, or the like, such as the electronic device described in more detail elsewhere herein.

As shown by reference number 405, a machine learning model may be trained using a set of observations. The set of observations may be obtained from training data (e.g., historical data), such as data gathered during one or more processes described herein. In some implementations, the machine learning system may receive the set of observations (e.g., as input) from one or more sensors or other suitable local data sources associated with the electronic device, as described elsewhere herein.

As shown by reference number 410, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from one or more sensors or other suitable local data sources associated with the electronic device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations associated with a pedometer may include a first feature of step count, a second feature of active duration, a third feature of rest period, and so on. As shown, for a first observation, the first feature may have a value of 9,746, the second feature may have a value of 14 hours, 6 minutes, and 12 seconds, the third feature may have a value of 14 minutes and 38 seconds, and so on. These features and feature values are provided as examples, and may differ in other examples. For example, the feature set may include one or more of the following features: gait type, distance traveled, heart rate, blood oxygen level, and/or calories burned, among other examples.

As shown by reference number 415, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 400, the target variable is liveness, which has a value of “non-human” for the first observation (e.g., indicating that the electronic device is being manipulated, operated, or otherwise handled by a non-human entity, which may be based on the pedometer data indicating a relatively large step count with a long active duration and a very short to negligible rest period).

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 420, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 425 to be used to analyze new observations.

As shown by reference number 430, the machine learning system may apply the trained machine learning model 425 to a new observation, such as by receiving a new observation and inputting the new observation to the trained machine learning model 425. As shown, the new observation may include a first feature of step count, a second feature of active duration, a third feature of rest period, and so on, as an example. The machine learning system may apply the trained machine learning model 425 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 425 may predict a value of non-human for the target variable of liveness for the new observation, as shown by reference number 435. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to disallow one or more actions that are initiated by the electronic device. The first automated action may include, for example, denying a request to terminate an SMS message sent by the electronic device.

As another example, if the machine learning system were to predict a value of human user for the target variable of liveness, then the machine learning system may provide a second (e.g., different) recommendation (e.g., allow the one or more actions that are initiated by the electronic device) and/or may perform or cause performance of a second (e.g., different) automated action (e.g., terminate the SMS message sent by the electronic device).

In some implementations, the trained machine learning model 425 may classify (e.g., cluster) the new observation in a cluster, as shown by reference number 440. The observations within a cluster may have a threshold degree of similarity. As an example, if the machine learning system classifies the new observation in a first cluster (e.g., SIM farm or spoof behaviors), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., human behaviors), then the machine learning system may provide a second (e.g., different) recommendation (e.g., the second recommendation described above) and/or may perform or cause performance of a second (e.g., different) automated action (e.g., the second automated action described above).

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above.

In some implementations, the trained machine learning model 425 may be re-trained using feedback information. For example, feedback may be provided to the machine learning model. The feedback may be associated with actions performed based on the recommendations provided by the trained machine learning model 425 and/or automated actions performed, or caused, by the trained machine learning model 425. In other words, the recommendations and/or actions output by the trained machine learning model 425 may be used as inputs to re-train the machine learning model (e.g., a feedback loop may be used to train and/or update the machine learning model). For example, the feedback information may include other sensor inputs that result in the same or a different liveness assessment, such as a motion detector input, an always-on face detection input, a location input, or another suitable input that is determined to indicate liveness or non-liveness of an entity operating the electronic device.

In this way, the machine learning system may apply a rigorous and automated process to determine whether the electronic device is being operated or otherwise handled by a live human user or a non-human entity attempting to replicate or simulate behaviors of a live human user. The machine learning system may enable recognition and/or identification of tens, hundreds, thousands, or millions of features and/or feature values for tens, hundreds, thousands, or millions of observations, thereby increasing accuracy and consistency and reducing delay associated with generating liveness information relative to requiring computing resources to be allocated for tens, hundreds, or thousands of operators to manually devise liveness assessment algorithms using the features or feature values.

As indicated above, FIG. 4 is provided as an example. Other examples may differ from what is described in connection with FIG. 4.

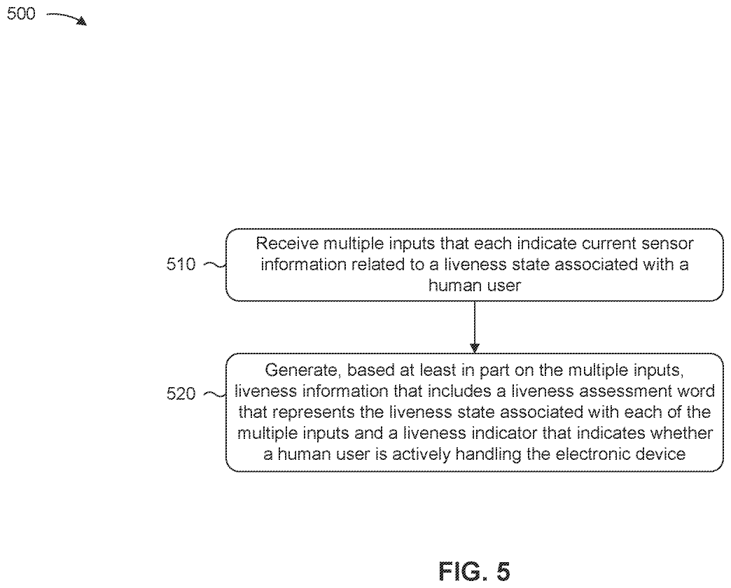

FIG. 5 is a flowchart of an example process 500 associated with liveness detection techniques that may be used to determine whether an electronic device is being handled by a human user, in accordance with the present disclosure. In some aspects, one or more process blocks of FIG. 5 are performed by an electronic device (e.g., electronic device 110). In some implementations, one or more process blocks of FIG. 5 may be performed by another device or a group of devices separate from or including the electronic device, such as a network node (e.g., network node 120). Additionally, or alternatively, one or more process blocks of FIG. 5 may be performed by one or more components of device 200, such as processor 210, memory 215, storage component 220, input component 225, output component 230, communication interface 235, sensor 240, and/or liveness detection component 245.

As shown in FIG. 5, process 500 may include receiving multiple inputs that each indicate current sensor information related to a liveness state associated with a human user (block 510). For example, the electronic device may receive multiple inputs that each indicate current sensor information related to a liveness state associated with a human user, as described above.

As further shown in FIG. 5, process 500 may include generating, based at least in part on the multiple inputs, liveness information that includes a liveness assessment word that represents the liveness state associated with each of the multiple inputs and a liveness indicator that indicates whether a human user is actively handling the electronic device (block 520). For example, the electronic device may generate, based at least in part on the multiple inputs, liveness information that includes a liveness assessment word that represents the liveness state associated with each of the multiple inputs and a liveness indicator that indicates whether a human user is actively handling the electronic device, as described above.

Process 500 may include additional aspects, such as any single aspect or any combination of aspects described below and/or in connection with one or more other processes described elsewhere herein.

In a first aspect, generating the liveness information includes analyzing the current sensor information associated with one or more of the multiple inputs using a liveness assessment algorithm to determine the liveness state.

In a second aspect, alone or in combination with the first aspect, the liveness information is generated using one or more machine learning models that are trained to detect whether a human user is actively handling the electronic device from the current sensor information.

In a third aspect, alone or in combination with one or more of the first and second aspects, the liveness information associated with the current sensor information is based at least in part on patterns associated with historical sensor information.

In a fourth aspect, alone or in combination with one or more of the first through third aspects, the liveness indicator has a value that is based at least in part on whether a threshold number or a threshold proportion of the multiple inputs indicate that a human user is actively handling the electronic device.

In a fifth aspect, alone or in combination with one or more of the first through fourth aspects, the liveness indicator has a value that indicates a probability that a human user is actively handling the electronic device.

In a sixth aspect, alone or in combination with one or more of the first through fifth aspects, the liveness indicator includes a flag that has a first value to indicate that a human user is actively handling the electronic device or a second value to indicate that the electronic device is not being actively handled by a human user.

In a seventh aspect, alone or in combination with one or more of the first through sixth aspects, process 500 includes transmitting the liveness information to a network node.

In an eighth aspect, alone or in combination with one or more of the first through seventh aspects, the liveness information is transmitted to the network node in connection with an SMS.

In a ninth aspect, alone or in combination with one or more of the first through eighth aspects, the liveness information is transmitted to the network node in connection with a data campaign to assess usage patterns associated with live human users and simulated human activity.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The following provides an overview of some Aspects of the present disclosure:

Aspect 1: A method performed by an electronic device, comprising: receiving multiple inputs that each indicate current sensor information related to a liveness state associated with a human user; and generating, based at least in part on the multiple inputs, liveness information that includes a liveness assessment word that represents the liveness state associated with each of the multiple inputs and a liveness indicator that indicates whether a human user is actively handling the electronic device.

Aspect 2: The method of Aspect 1, wherein generating the liveness information includes analyzing the current sensor information associated with one or more of the multiple inputs using a liveness assessment algorithm to determine the liveness state.

Aspect 3: The method of any of Aspects 1-2, wherein the liveness information is generated using one or more machine learning models that are trained to detect whether a human user is actively handling the electronic device from the current sensor information.

Aspect 4: The method of any of Aspects 1-3, wherein the liveness information associated with the current sensor information is based at least in part on patterns associated with historical sensor information.

Aspect 5: The method of any of Aspects 1-4, wherein the liveness indicator has a value that is based at least in part on whether a threshold number or a threshold proportion of the multiple inputs indicate that a human user is actively handling the electronic device.

Aspect 6: The method of any of Aspects 1-5, wherein the liveness indicator has a value that indicates a probability that a human user is actively handling the electronic device.

Aspect 7: The method of any of Aspects 1-6, wherein the liveness indicator includes a flag that has a first value to indicate that a human user is actively handling the electronic device or a second value to indicate that the electronic device is not being actively handled by a human user.

Aspect 8: The method of any of Aspects 1-7, further comprising: transmitting the liveness information to a network node.

Aspect 9: The method of Aspect 8, wherein the liveness information is transmitted to the network node in connection with an SMS.

Aspect 10: The method of Aspect 8, wherein the liveness information is transmitted to the network node in connection with a data campaign to assess usage patterns associated with live human users and simulated human activity.

Aspect 11: A electronic device for wireless communication, comprising: a memory; and one or more processors, coupled to the memory, configured to: receive multiple inputs that each indicate current sensor information related to a liveness state associated with a human user; and generate, based at least in part on the multiple inputs, liveness information that includes a liveness assessment word that represents the liveness state associated with each of the multiple inputs and a liveness indicator that indicates whether a human user is actively handling the electronic device.

Aspect 12: The electronic device of Aspect 11, wherein the one or more processors, to generate the liveness information, are configured to analyze the current sensor information associated with one or more of the multiple inputs using a liveness assessment algorithm to determine the liveness state.

Aspect 13: The electronic device of any of Aspects 11-12, wherein the liveness information is generated using one or more machine learning models that are trained to detect whether a human user is actively handling the electronic device from the current sensor information.

Aspect 14: The electronic device of any of Aspects 11-13, wherein the liveness information associated with the current sensor information is based at least in part on patterns associated with historical sensor information.

Aspect 15: The electronic device of any of Aspects 11-14, wherein the liveness indicator has a value that is based at least in part on whether a threshold number or a threshold proportion of the multiple inputs indicate that a human user is actively handling the electronic device.

Aspect 16: The electronic device of any of Aspects 11-15, wherein the liveness indicator has a value that indicates a probability that a human user is actively handling the electronic device.

Aspect 17: The electronic device of any of Aspects 11-16, wherein the liveness indicator includes a flag that has a first value to indicate that a human user is actively handling the electronic device or a second value to indicate that the electronic device is not being actively handled by a human user.

Aspect 18: The electronic device of any of Aspects 11-17, wherein the one or more processors are further configured to: transmit the liveness information to a network node. transmit the liveness information to a network node.

Aspect 19: The electronic device of Aspect 18, wherein the liveness

information is transmitted to the network node in connection with an SMS.

Aspect 20: The electronic device of Aspect 18, wherein the liveness information is transmitted to the network node in connection with a data campaign to assess usage patterns associated with live human users and simulated human activity.

Aspect 21: A non-transitory computer-readable medium storing a set of instructions for wireless communication, the set of instructions comprising: one or more instructions that, when executed by one or more processors of an electronic device, cause the electronic device to: receive multiple inputs that each indicate current sensor information related to a liveness state associated with a human user; and generate, based at least in part on the multiple inputs, liveness information that includes a liveness assessment word that represents the liveness state associated with each of the multiple inputs and a liveness indicator that indicates whether a human user is actively handling the electronic device.

Aspect 22: The non-transitory computer-readable medium of Aspect 21. wherein the one or more instructions, that cause the electronic device to generate the liveness information, cause the electronic device to analyze the current sensor information associated with one or more of the multiple inputs using a liveness assessment algorithm to determine the liveness state.

Aspect 23: The non-transitory computer-readable medium of any of Aspects 21-22, wherein the liveness information is generated using one or more machine learning models that are trained to detect whether a human user is actively handling the electronic device from the current sensor information.

Aspect 24: The non-transitory computer-readable medium of any of Aspects 21-23, wherein the liveness indicator has a value that is based at least in part on whether a threshold number or a threshold proportion of the multiple inputs indicate that a human user is actively handling the electronic device.

Aspect 25: The non-transitory computer-readable medium of any of Aspects 21-24, wherein the liveness indicator has a value that indicates a probability that a human user is actively handling the electronic device.

Aspect 26: An apparatus for wireless communication, comprising: means for receiving multiple inputs that each indicate current sensor information related to a liveness state associated with a human user; and means for generating, based at least in part on the multiple inputs, liveness information that includes a liveness assessment word that represents the liveness state associated with each of the multiple inputs and a liveness indicator that indicates whether a human user is actively handling the electronic device.

Aspect 27: The apparatus of Aspect 26, wherein the means for generating the liveness information includes means for analyzing the current sensor information associated with one or more of the multiple inputs using a liveness assessment algorithm to determine the liveness state.

Aspect 28: The apparatus of any of Aspects 26-27, wherein the liveness information is generated using one or more machine learning models that are trained to detect whether a human user is actively handling the electronic device from the current sensor information.

Aspect 29: The apparatus of any of Aspects 26-28, wherein the liveness indicator has a value that is based at least in part on whether a threshold number or a threshold proportion of the multiple inputs indicate that a human user is actively handling the electronic device.

Aspect 30: The apparatus of any of Aspects 26-29, wherein the liveness indicator has a value that indicates a probability that a human user is actively handling the electronic device.

Aspect 31: A system configured to perform one or more operations recited in one or more of Aspects 1-30.

Aspect 32: An apparatus comprising means for performing one or more operations recited in one or more of Aspects 1-30.

Aspect 33: A non-transitory computer-readable medium storing a set of instructions, the set of instructions comprising one or more instructions that, when executed by a device, cause the device to perform one or more operations recited in one or more of Aspects 1-30.

Aspect 34: A computer program product comprising instructions or code for executing one or more operations recited in one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by an electronic device, comprising:
receiving multiple inputs that each indicate current sensor information related to a liveness state associated with a human user; and
generating, based at least in part on the multiple inputs, liveness information that includes a liveness assessment word that represents the liveness state associated with each of the multiple inputs and a liveness indicator that indicates whether a human user is actively handling the electronic device.

2. The method of claim 1, wherein generating the liveness information includes analyzing the current sensor information associated with one or more of the multiple inputs using a liveness assessment algorithm to determine the liveness state.

3. The method of claim 1, wherein the liveness information is generated using one or more machine learning models that are trained to detect whether a human user is actively handling the electronic device from the current sensor information.

4. The method of claim 1, wherein the liveness information associated with the current sensor information is based at least in part on patterns associated with historical sensor information.

5. The method of claim 1, wherein the liveness indicator has a value that is based at least in part on whether a threshold number or a threshold proportion of the multiple inputs indicate that a human user is actively handling the electronic device.

6. The method of claim 1, wherein the liveness indicator has a value that indicates a probability that a human user is actively handling the electronic device.

7. The method of claim 1, wherein the liveness indicator includes a flag that has a first value to indicate that a human user is actively handling the electronic device or a second value to indicate that the electronic device is not being actively handled by a human user.

8. The method of claim 1, further comprising:
transmitting the liveness information to a network node.

9. The method of claim 8, wherein the liveness information is transmitted to the network node in connection with a short message service.

10. The method of claim 8, wherein the liveness information is transmitted to the network node in connection with a data campaign to assess usage patterns associated with live human users and simulated human activity.

11. A electronic device for wireless communication, comprising:
a memory; and
one or more processors, coupled to the memory, configured to:
receive multiple inputs that each indicate current sensor information related to a liveness state associated with a human user; and
generate, based at least in part on the multiple inputs, liveness information that includes a liveness assessment word that represents the liveness state associated with each of the multiple inputs and a liveness indicator that indicates whether a human user is actively handling the electronic device.

12. The electronic device of claim 11, wherein the one or more processors, to generate the liveness information, are configured to analyze the current sensor information associated with one or more of the multiple inputs using a liveness assessment algorithm to determine the liveness state.

13. The electronic device of claim 11, wherein the liveness information is generated using one or more machine learning models that are trained to detect whether a human user is actively handling the electronic device from the current sensor information.

14. The electronic device of claim 11, wherein the liveness information associated with the current sensor information is based at least in part on patterns associated with historical sensor information.

15. The electronic device of claim 11, wherein the liveness indicator has a value that is based at least in part on whether a threshold number or a threshold proportion of the multiple inputs indicate that a human user is actively handling the electronic device.

16. The electronic device of claim 11, wherein the liveness indicator has a value that indicates a probability that a human user is actively handling the electronic device.

17. The electronic device of claim 11, wherein the liveness indicator includes a flag that has a first value to indicate that a human user is actively handling the electronic device or a second value to indicate that the electronic device is not being actively handled by a human user.

18. The electronic device of claim 11, wherein the one or more processors are further configured to:
transmit the liveness information to a network node.

19. The electronic device of claim 18, wherein the liveness information is transmitted to the network node in connection with a short message service.

20. The electronic device of claim 18, wherein the liveness information is transmitted to the network node in connection with a data campaign to assess usage patterns associated with live human users and simulated human activity.

21. A non-transitory computer-readable medium storing a set of instructions for wireless communication, the set of instructions comprising:
one or more instructions that, when executed by one or more processors of an electronic device, cause the electronic device to:
receive multiple inputs that each indicate current sensor information related to a liveness state associated with a human user; and
generate, based at least in part on the multiple inputs, liveness information that includes a liveness assessment word that represents the liveness state associated with each of the multiple inputs and a liveness indicator that indicates whether a human user is actively handling the electronic device.

22. The non-transitory computer-readable medium of claim 21, wherein the one or more instructions, that cause the electronic device to generate the liveness information, cause the electronic device to analyze the current sensor information associated with one or more of the multiple inputs using a liveness assessment algorithm to determine the liveness state.

23. The non-transitory computer-readable medium of claim 21, wherein the liveness information is generated using one or more machine learning models that are trained to detect whether a human user is actively handling the electronic device from the current sensor information.

24. The non-transitory computer-readable medium of claim 21, wherein the liveness indicator has a value that is based at least in part on whether a threshold number or a threshold proportion of the multiple inputs indicate that a human user is actively handling the electronic device.

25. The non-transitory computer-readable medium of claim 21, wherein the liveness indicator has a value that indicates a probability that a human user is actively handling the electronic device.

26. An apparatus for wireless communication, comprising:
means for receiving multiple inputs that each indicate current sensor information related to a liveness state associated with a human user; and
means for generating, based at least in part on the multiple inputs, liveness information that includes a liveness assessment word that represents the liveness state associated with each of the multiple inputs and a liveness indicator that indicates whether a human user is actively handling the apparatus.

27. The apparatus of claim 26, wherein the means for generating the liveness information includes means for analyzing the current sensor information associated with one or more of the multiple inputs using a liveness assessment algorithm to determine the liveness state.

28. The apparatus of claim 26, wherein the liveness information is generated using one or more machine learning models that are trained to detect whether a human user is actively handling the apparatus from the current sensor information.

29. The apparatus of claim 26, wherein the liveness indicator has a value that is based at least in part on whether a threshold number or a threshold proportion of the multiple inputs indicate that a human user is actively handling the apparatus.

30. The apparatus of claim 26, wherein the liveness indicator has a value that indicates a probability that a human user is actively handling the apparatus.
